(19) United States
(12) Patent Application Publication
(10) Pub. No.: US 2020/0226216 A1
(43) Pub. Date: Jul. 16, 2020

(54) CONTEXT-SENSITIVE SUMMARIZATION

(71) Applicant: Microsoft Technology Licensing, LLC, Redmond, WA (US)

(72) Inventors: Marius A. MARIN, Seattle, WA (US); Alexandre ROCHETTE, Montreal (CA); Daniel BOIES, Saint-Lambert (CA); Vashutosh AGRAWAL, Bellevue, WA (US); Bodin DRESEVIC, Bellevue, WA (US)

(73) Assignee: Microsoft Technology Licensing, LLC, Redmond, WA (US)

(21) Appl. No.: 16/245,039

(22) Filed: Jan. 10, 2019

(51) Int. Cl. G06F 17/27; G10L 15/22; G06F 16/2457; G06N 20/00

(52) U.S. Cl. CPC G06F 17/2785; G06F 17/274; G06N 20/00; G06F 16/24578; G10L 15/22

(57) ABSTRACT

This document relates to compression of information into a human-readable format, such as a sentence or phrase. Generally, the disclosed techniques can extract values, such as purposes and topics, from information items and generate compressed representations of the information items that include the extracted values. In some cases, machine learning models can be employed to extract the values, and also to rank the values for inclusion in the compressed representations.

### BACKGROUND

Traditionally, automated efforts to summarize information have focused on limited application scenarios. For example, automated techniques for summarizing news articles have met with some success. However, there are many scenarios where existing automated summarization techniques tend to be overinclusive by burdening users with duplicative or irrelevant details.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for compressing information. One example includes a method or technique that can be performed on a computing device. The method or technique can include receiving an information item for presentation to a user and performing a lossy compression process on the information item. The lossy compression process can include extracting purposes from the information item, where the purposes are selected from a restricted space of purposes. The lossy compression process can also include extracting topics from the information item, where the topics are selected from a restricted topic vocabulary space. The lossy compression process can include performing a ranking process on the extracted purposes and the extracted topics and, based at least on the ranking process, identifying a selected purpose of the information item and a selected topic of the information item. The lossy compression process can also include generating a compressed representation of the information item, where the compressed representation includes the selected purpose and the selected topic. The method or technique can also include outputting the compressed representation.

Another example includes a system that entails a hardware processing unit and a storage resource. The storage resource can store computer-readable instructions which, when executed by the hardware processing unit, cause the hardware processing unit to receive a collection of conversational information items that reflect communication among a plurality of participants. The computer-readable instructions can also cause the hardware processing unit to extract one or more values from individual conversational information items of the collection, identify collection information associated with the collection of conversational information items, and using a predetermined grammar, generate a compressed representation of the collection. The compressed representation can be generated based at least on the collection information and the one or more values extracted from the individual conversational information items.

Another example includes a computer-readable storage medium storing instructions which, when executed by a processing device, cause the processing device to perform acts. The acts can include receiving one or more information items and performing a lossy compression process on the one or more information items. The lossy compression process can include extracting values from the one or more information items and including the extracted values in an initial summary. The acts can also include outputting the initial summary to a user and receiving a user query responsive to the initial summary. The acts can also include re-ranking the values extracted during the lossy compression process, based at least on the user query. The acts can also include generating a refined summary based at least on the re-ranking, and outputting the refined summary to the user.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIGS. 1, 3, 4, 6, 8, and 9 illustrate exemplary scenarios in which the disclosed implementations can be employed.

FIGS. 2, 5, and 7 illustrate exemplary modules that can be employed to perform the disclosed concepts.

FIG. 10 illustrates an example system, consistent with some implementations of the present concepts.

FIG. 11 illustrates an example method or technique for compressing information, consistent with some implementations of the present concepts.

### DETAILED DESCRIPTION

### Overview

Broadly speaking, one important use of computing technologies involves providing information content to users. For example, online news articles, search engines, and social media deliver a wealth of information content to a user. More recently, automated digital assistants have been developed to assist users in many different types of tasks, including the gathering of information content.

Typically, automated agents such as web browsers, email clients, and digital assistants will provide users with access to raw information content, including personal content such as emails, calendar information and personal social media feeds, as well as public content, such as news, local event listings, public RSS feeds, etc. In some circumstances, such as when a user is alone in a quiet room, the users can dedicate their full attention to the interaction with the automated agent. In these circumstances, the user is typically well-positioned to fully understand the information content delivered in raw form—e.g., by reading or listening to an entire email thread, listening to voicemails, etc. However, in other circumstances, users may have distractions that prevent them from devoting their full attention to the information content being presented. As but two examples, a user may be driving their personal vehicle or engaging in domestic activities at home. Under these circumstances, the raw information content may be too complex for the user to understand unless they cease their other activities so they can dedicate their full attention to understanding the raw information content.

One way to evaluate information content presented to a user is based on the “cognitive load” of the information content. The term “cognitive load” refers to the amount of cognitive effort required to understanding the information content of a given information item, such as a document, audio recording, video recording, etc. Often, raw information content has high cognitive load, because the raw information content is generated under the assumption that the consuming user can give their undivided attention to the raw information content. For example, an email sender typically writes emails under the assumption that the recipient will read their work emails in their office, a person usually leaves a voicemail expecting the recipient to listen to the entire voicemail, etc.

Generally, the disclosed techniques can summarize raw information content of information items to produce summarized information content that places a relatively lower cognitive load on the user than the raw information content of the information items. The disclosed techniques can do so in a context-sensitive manner, e.g., by detecting the user's context and determining whether to offer a low cognitive load summary based on the context. Thus, the disclosed implementations can tailor the complexity of information content presented to a user according to the user's context.

Existing approaches to summarizing raw information content have largely focused on limited domains, where the information items have a predictable format and/or there are readily available sources of training data. For example, news articles tend to have headlines that are written in a relatively predictable structure, and there are publicly available databases of news articles with human-generated summaries that can serve as training data for models tailored to summarization of news articles.

However, users receive a great deal of raw information content from other domains, where communication can be more conversational. For example, users may communicate via email, text messages, and/or social media threads that involve many different people, change topic over time, and tend to use informal, conversational language that lacks the structure typically found in a news article. Previous techniques for summarizing information content are not tailored to conversational information items such as these, as they often do not consider user relationships, user preferences, and user context. In addition, there is also a paucity of available training data, as users typically do not write manual summaries of conversational information items, in contrast to the news article scenario where most news articles are accompanied by a headline that can be used as a labeled training example. Furthermore, previous techniques for summarizing information content tend to produce relatively complex, lengthy summaries that may not be suitable for presentation to a user whose attention is diverted by an activity such as driving or housework.

In domains other than summarization, compression techniques have been adopted for representing information in compact form. For example, a computer document can be compressed using a lossless compression algorithm that reduces the size of the document in bytes, and allows the document to be recovered at a later time. Generally, however, compressed representations of data are provided in computer-readable formats that are not suitable for presentation to human users.

Generally speaking, the disclosed implementations endeavor to summarize relevant information content for a user in consideration of the user's current context. The disclosed implementations can do so by compressing information content into a lower-dimensional space that is nevertheless human-readable. For example, as discussed more below, the disclosed implementations can perform a lossy compression process on an information item to obtain one or more summary sentences or phrases that represent information content. The summary sentences or phrases can include values, such as topics or purposes, that are extracted from the information item and projected into a restricted space. As a consequence, the disclosed implementations can effectively compress an information item into a human-readable form that has a relatively small data footprint (i.e., size in bytes). In addition to providing compact representations of information items, the disclosed implementations can also offer summaries that have a relatively low cognitive load.

The disclosed implementations can be applied to various types of information items, including conversational information items and non-conversational information items. The term “information item” is used herein to describe any source of information, e.g., in a text, audio, video, or image format. For example, the disclosed implementations can be applied to conversational information items such as email, text, or instant message threads, web forums, transcriptions of in-person discussions or voicemails, etc. The term “conversational information item” is used to refer to information items that are expressed to other users in a conversational or discussion-oriented format. For example, the disclosed implementations can be applied to non-conversational information items such as newspaper articles, encyclopedia entries, biographies, instruction manuals, etc. The term “non-conversational information item” is used to refer to information items that are expressed in a non-conversational format.

The term “collection of information items” generally refers to multiple information items that have some predefined relationship, e.g., a group of news articles on the same topic. The term “collection of conversational information items” refers to two or more conversational information items involving two or more participants, where at least one of the conversational information items is responsive to a previous conversational information item. The disclosed implementations can provide a user with compressed representations (e.g., summaries) of information items that are appropriate given the user's current context, as discussed more below. In cases where the information items include conversational information items, the compressed representations can be generated using models that are partially trained using a first data set of annotated non-conversational information items, such as newspaper articles or encyclopedia entries, and subsequently adapted for conversational information items using a second data set of annotated conversational data items.

### First Example User Experience

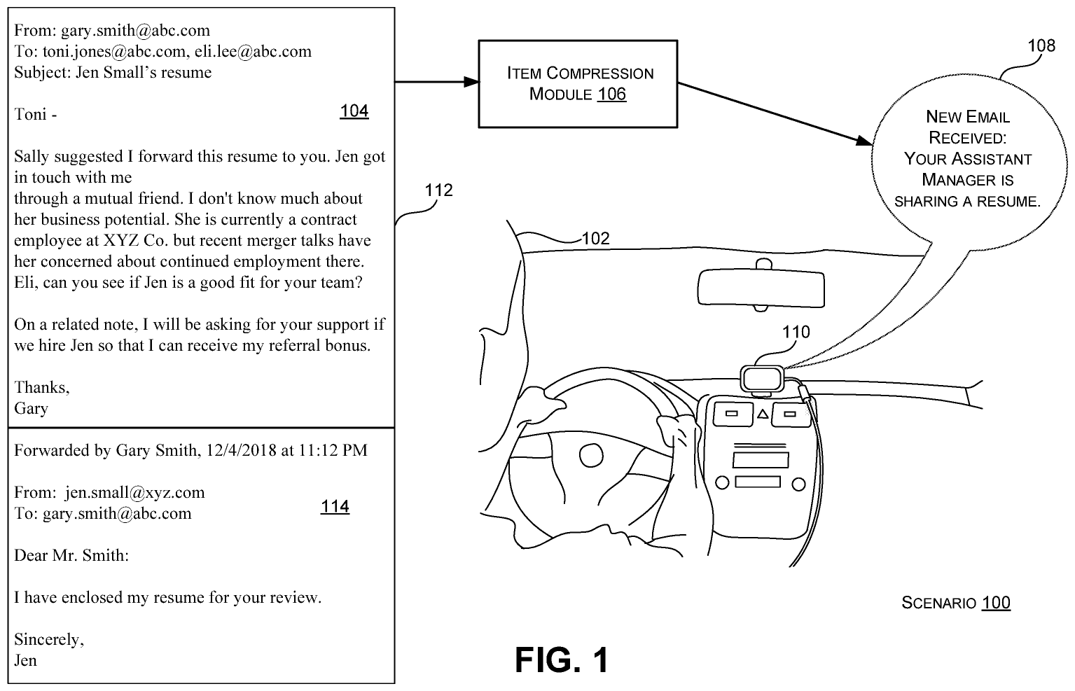

FIG. 1 illustrates an exemplary scenario 100 where the disclosed implementations can be employed. A user 102 can receive an information item such as an email 104, which can be processed by an item compression module 106. The item compression module can determine that the user is currently driving, and perform a context-sensitive compression process on the email to obtain a compressed representation 108 of the email that is appropriate given the user's driving context. In this example, the compressed representation is a single sentence summarizing the received email. The user's mobile device 110 can produce an audible output that announces the sentence to the user. Note that some implementations may play the audible output back through speakers of the user's car, e.g., via Bluetooth. In addition, note that email 104 is part of an email thread 112 which also includes email 114. Email thread 112 is an example of a collection of conversational information items and is used in a number of summarization examples discussed further below.

In this example, which continues below, a manager named Toni Jones (user 102) works at a company called ABC Corp. Toni receives email 104 from her subordinate, an assistant manager named Gary Smith. Gary is forwarding Toni an email 114 from an acquaintance named Jen Small, who is seeking a position at ABC Corp., and has submitted her resume to Gary. Gary has also sent email 104 to a technical lead named Eli Lee, as discussed more below.

### Example Item Compression Module

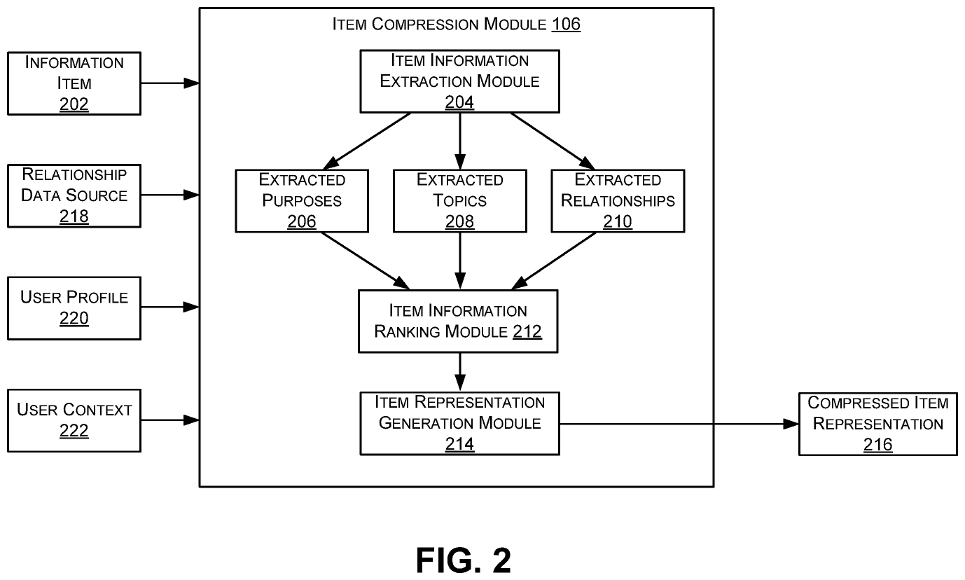

FIG. 2 illustrates exemplary components of item compression module 106. The following discussion focuses on generating a compressed representation of a single information item 202, such as emails 104 and/or 114.

Initially, an information item 202 is fed into an item information extraction module 204, which extracts various values such as extracted purposes 206, extracted topics 208, and extracted relationships 210. These pieces of information can be ranked by an item information ranking module 212. Based on a ranking process performed using the purposes, topics, and/or relationships, an item representation generation module 214 can generate a compressed item representation 216, as discussed more below.

With respect to the extracted purposes 206, some implementations may define an enumerated list of information item purposes, and the item information extraction module 204 can select one or more purposes from the enumerated list for each information item 202. As a few examples, the enumerated purposes can include {InformFact, InformOpinion, Share, Propose, AskQuestion, AnswerQuestion, . . . }, and so on. The InformFact purpose can indicate that the purpose of the information item is to inform a user of one or more facts. The InformOpinion purpose can indicate that the purpose of the information item is to inform a user of one or more opinions. The Share purpose can indicate that the purpose of the information item is to share information, e.g., that was provided to the sender by another user. The Propose purpose can indicate that the purpose of the information item is to propose a course of action, conveying that the recipient may be expected to confirm agreement with the course of action or otherwise decline. The AskQuestion purpose can indicate that the purpose of the information item is to answer a question, and the AnswerQuestion purpose can indicate that the purpose of the information item involves answering a question. Other purposes may be enumerated for greetings, confirming/denying previously-exchanged information, committing to activities, etc. In some implementations, one or more purpose detection models, such as support vector machines, are used to determine one or more purposes of a given information item from an enumerated list of 20-25 purposes, as discussed more below.

With respect to the extracted topics 208, some implementations may define a topic vocabulary, and words from that vocabulary may be used by the item information extraction module 204 as the topics for a given information item 202. In some cases, the topic vocabulary includes the set of all words in the information item and any other information items that are part of the same collection of information items. In further implementations, the topic vocabulary can be expanded with one or more other commonly-used words from a large corpus of text. Example topics can include “Dave's resume,” “referral bonus,” “Sunday's football game,” etc. Generally, restricting the topics to a vocabulary primarily derived from the underlying information items can ensure that the terminology used for the topic is familiar to the user. In some implementations, the topic is extracted by one or more topic detection models. For example, one or more neural networks can be trained to output topics. Alternatively, one or more neural networks can be trained to output a set of features that can be input to one or more gradient-boosted decision trees. The one or more gradient-boosted decision trees can output one or more topics for that information item, as discussed more below.

With respect to the relationships, some implementations may reference an external relationship data source 218. The relationship data source can include a knowledge graph that identifies relationships between various entities. Examples include organizational charts, social media relationships, databases of known public figures, or any other source of data that can be used to determine the respective relationships of individual senders or recipients of a conversational information item. Using the relationship data source, the disclosed implementations can infer relationships, such as manager, subordinate, etc. The relationships can be used for generating compressed representations of information items as discussed more below. For example, some implementations can replace names of participants to reflect the extracted relationships, e.g., by replacing a person's name with an extracted title. In some implementations, the relationships are extracted using a rule-based approach. In further implementations, a statistical model can be used to preferentially select more important relationships for a given user.

Furthermore, in some implementations, the item information ranking module 212 may access a user profile 220. For example, the user profile may be updated over time as the user interacts with the item compression module 106. In some implementations, the user profile may reflect previous topics that the user has expressed interest in, other individuals about which the user has requested information, etc. The item information ranking module may rank various topics considering the user's history of expressing interest in those topics, or documents/folders that the user tends to access frequently, etc. As another example, if the user profile indicates that the user typically expresses interest in forwarded content and less interest in the opinions of others, the item information ranking module might rank the Share purpose relatively higher than the InformOpinion purpose. Similarly, if the user tends to ignore information provided by their technical lead but expresses interest in information provided by their second-level supervisor, the item information ranking module may rank the second-level supervisor relationship higher than the technical lead relationship. As discussed more below, some implementations may use gradient-boosted decision trees as a ranking model to rank purposes, topics, and/or relationships.

In addition to the ranked purposes, topics, and relationships, the item information ranking module 212 can also access a user context 222. The user context can indicate whether the user is presently engaged in an activity such as driving a car or doing chores. The user context can also provide information such as whether the user is in a public place, in their office, at home, etc. The item information ranking module can rank topics or relationships differently depending on the user context, e.g., ranking work-related topics/relationships above personal topics/relationships when the user is at work or commuting to their office, and ranking personal topics/relationships above work-related topics/relationships when the user is at home.

Given a ranked set of purposes, topics, and/or relationships, the item representation generation module 214 can generate compressed item representation 216. In some cases, the compressed item representation can be a single sentence that includes the highest-ranking purpose and/or highest-ranking topic, as discussed more below.

### First Summary Generation Example

The following discusses how the item compression module 106 might generate the compressed representation 108 shown in FIG. 1, which states that “Your Assistant Manager is sharing a resume.”

First, the item information extraction module 204 can extract purposes such as InformFact and Share from email 104, and extract topics such as “resume” and “referral bonus.” Viewed from one perspective, the InformFact purpose can reflect that the sender is informing the recipient that they would like to receive a referral bonus, and the Share purpose can inform the recipient that the sender is sharing information received from an external source, e.g., the resume from a previous sender.

Next, the item information ranking module 212 can rank the extracted purposes and topics. In some cases, the ranking is performed separately for purposes and topics. For example, the Share purpose might be ranked higher than the InformFact purpose, and the resume topic might be ranked higher than the referral bonus topic. In this case, the Share purpose is associated with the resume topic, and the Inform Fact purpose is associated with the referral bonus topic. Thus, generating a summary from the top-ranked purpose and top-ranked topic, in this example, can produce a consistent summary where the top-ranked purpose matches the top-ranked topic.

However, in some cases, the top-ranked purpose and top-ranked topic may not relate to one another. For example, suppose the referral bonus topic were ranked higher than the resume topic but the Share purpose were still ranked higher than the InformFact purpose. Generating a summary from the Share purpose with the referral bonus topic would produce an inconsistent result, as the sender is not sharing a referral bonus, but rather a resume. Thus, in some implementations, the purposes and topics are jointly ranked together, e.g., in purpose-topic pairs. Then, summaries can be generated for one or more of the highest-ranked purpose-topic pairs. By ranking purposes and topics together, it is less likely that summaries will be produced having inconsistent topics and purposes.

After the ranking process, a compressed representation 108 of the email 104 can be generated by the item representation generation module 214. For example, suppose a joint ranking process is employed and the highest-ranked purpose-topic pair includes the Share purpose and the resume topic. The summary sentence produced can be “Your assistant manager is sharing a resume,” as shown in FIG. 1. On the other hand, if the Inform purpose and referral bonus topic had been ranked more highly, the summary could be “Your assistant manager informed you that they will request a referral bonus.”

Note that the summary, in this example, includes a selected topic, “resume,” and a selected purpose, “shared.” In addition, the summary includes an extracted relationship, e.g., “Gary Smith” has been replaced with “assistant manager.” Thus, the summary includes three different values extracted by the item information extraction module 204.

As a few other examples of summaries, consider an email that informs a recipient of an urgent upcoming due date for a document review project and confirms that the sender will attend an unrelated conference call, the generated purposes could include InformFact and CommitToActivity. The topics could include “document review project” and “conference call.” A first summary could be generated that states “Your manager Dave has informed you of a document review project.” A second summary could be generated that states “Your manager Dave has committed to attend Tuesday's conference call.” In these examples, the summaries include extracted topics, purposes, and relationships conveyed in a compact natural language format, e.g., a single summary sentence.

Note that each example summary sentence is relatively short and limited to one purpose/topic combination. In addition, the sentences share a common, simple sentence structure, which can be used each time a given information item is summarized for the user. These characteristics can reduce the cognitive load for the user, as the user not only consistently receives relatively simple sentences reflecting a single topic and purpose, but the user consistently receives the same sentence format each time a new summary is generated.

The summary sentences may be produced using either rule-based natural language generation techniques or machine learning methods, such as involving syntactic and semantic parsing or artificial neural networks. In some cases, a predefined number of sentences for high-ranking purposes and topics is output, and other sentences for lower-ranking purposes/topics are not generated and/or output. As noted, summary generation grammars can serve as templates for producing a given summary sentence. For example, one template might be: [SENDER] is [PURPOSE] you about [TOPIC]. Here, the “sender” field can be filled in with the sender's name and/or an extracted relationship, such as “assistant manager.” The “purpose” field can be filled in by mapping the extracted “share” purpose into an appropriate verb tense, for example, “is sharing.” The topic field can be populated with the extracted topic.

In some cases, the level of detail or total amount of information provided by a given summary is context-sensitive. For example, when the user is driving, only one sentence may be generated per information item, whereas if the user is working in their home, multiple sentences may be generated. As another example, the complexity of summary sentence structures can vary depending on the user's context, e.g., simpler sentence structures when the user is driving and more complex sentence structures when doing chores.

For example, some implementations may define a first, very simple grammar for simple summary sentences that are provided when the user's context indicates the user is involved in an activity that requires intense concentration, such as driving. A second grammar of moderate complexity may be used in scenarios where the user's context indicates that the user is engaged in an activity that requires moderate concentration, such as doing housework. In scenarios where the user's context indicates that the user can dedicate their full attention to the information item, there may be no restriction to any particular grammar. Rather, the raw information content of the information item may be presented, or an abstractive summary of the information item. The grammars involved may specify where the extracted purposes, topics, and/or relationships appear in a given sentence structure.

Note that summary 110 shown in FIG. 1 uses a relatively simple sentence structure that could be generated using a relatively simple first grammar. Alternatively, had the user been doing housework, a more complex summary could have been generated using a second grammar. For example, a more complex summary could involve a compound sentence that conveys multiple topics and/or purposes, e.g., “Your assistant manager shared a resume and informed you that they will request a referral bonus.” Note that the additional complexity of sentence structure allowed for incorporation of an additional topic and purpose that were omitted from the first summary.

### Further Summary Examples

In addition, in some implementations, the item compression module 106 may use context to determine what information is presented. As one example, a single information item can include sensitive information such as a medical information and less sensitive information, e.g., relating to a job promotion or award. In some cases, the item information ranking module 212 can rank sensitive information lower in a public context and higher in a private context. Thus, in a public context, the job promotion or award topic may be ranked higher, and in a private context, the medical information topic might be ranked higher. In implementations where the ranker jointly ranks purposes and topics, this can also have the effect of increasing the ranking of whatever purpose is associated with the more pertinent topic.

As another example, the item information ranking module 212 can rank work-related topics relatively higher during work hours, and personal or leisure-related topics may be ranked relatively higher later in the day. As another example, distressing information may be omitted in scenarios where this information might endanger the recipient, e.g., the summary may not inform the user of a death in their family if the user is driving. This can be accomplished during ranking, during text generation, or by a post-text generation filtering step, e.g., based on one or more manually-created rules.

In further implementations, the item information ranking module 212 can consider internal signals within a given information item that were not previously mentioned. For example, consider a relatively long email that discusses a number of different topics. Some implementations may decompose the email into different identified speech acts, and rank the purposes and/or topics in the information item based on the number of speech acts for each topic. In further implementations, speech acts can be ranked in relative importance based on internal signals, such as punctuation (e.g., exclamation points), highlighting (e.g., bold, italics, large font, etc.), and/or relative ordering and absolute positioning within a document. Once the speech acts have been ranked, a given topic and/or purpose can be ranked based on the relative importance of the underlying speech acts related to that topic or purpose.

With respect to ordering and positioning, note that important speech acts often tend to occur at the beginning or end of a document. In addition, speech acts occurring in the middle of a document may have conceptual dependencies on preceding speech acts. By preferentially ranking speech acts by giving consideration to ordering and positioning, the disclosed implementations may avoid generating summaries that are difficult to comprehend because they include information that requires knowledge that the user does not yet have.

In other implementations, the item information ranking module 212 may first identify the respective importance of individual topics, and then subsequently identify the speech acts associated with each topic. The summary can be generated by the generation module 214 to reflect those speech acts associated with relatively more important topics, and omit those speech acts associated with less important topics.

Likewise, speech acts and associated topics can be ranked in importance based on identified relationships. For example, if a peer sends an email to their colleague that focuses mostly on a project they are working on together but also mentions something that their supervisor said about upcoming reviews, the item information ranking module 212 may associate the review topic with the supervisor and rank this topic relatively higher than the project, based on the supervisory relationship being presumably more important than the peer relationship.

### Compressed Representation Characteristics

Recall that conventional abstractive or extractive techniques for automating the generation of a summary tended to err on the side of generating longer summaries that convey such information in a longer format. The disclosed implementations can bound the cognitive load by consistently returning a concise summary, irrespective of the length of the original information items. Thus, viewed from one perspective, the disclosed implementations may offer a concise summary that gives up some completeness in favor of a concise format that provides a low cognitive load. Several of the features discussed above can contribute to the ability of the disclosed implementations to do so.

First, the disclosed implementations can consistently return summaries that conform to limited number of sentences or phrases, and use a predefined sentence or phrase structure. Conventional approaches to automated summarization tend to output varying numbers of sentences with arbitrary and complex sentence structures, consistent with their goal of providing complete summaries. By bounding the number of sentences in a given summary and restricting the grammar used to generate the sentences, the disclosed implementations can ensure that the summaries have a consistent length and relatively simple sentence structure. In contrast, the disclosed implementations can receive an information item of arbitrary length and perform a lossy compression of the information item into a constrained information space.

Using a restricted vocabulary space for topics is another technique disclosed herein for constraining the information space of generated summaries. Consider existing abstractive techniques that operate by generating semantic representations of information items, and are trained to generate summaries that have semantic representations that are similar to the semantic representations of the information items. In the course of generating the abstractive summaries, a wide vocabulary is often used. While this can allow abstractive techniques to provide expressive summaries, this also tends to increase the cognitive load on the user because the words used in abstractive summaries are not necessarily present in the underlying information items. For example, some companies may tend to use a specific jargon, and abstractive summaries may tend to substitute more general-purpose words. By restricting the vocabulary used for topic generation primarily to the words in the underlying input information items and then using those topics in the generated summaries, the disclosed implementations can reduce the cognitive burden on the user by using terminology that is consistent with what tends to be used in their communication with others. In other words, the original information item is compressed by projecting the information item into a restricted topic space. This approach is flexible, because the topic space can vary with the underlying information items, but at the same time significantly reduces the topic space. Accordingly, the most salient topic information can be conveyed by the summary in a very compact format.

Using a restricted vocabulary space for purposes is another technique disclosed herein for constraining the information space of generated summaries. Generally, conventional abstractive and extractive techniques tend to err on the side of covering most or all purposes expressed in a given information item, and do not provide significant restrictions on how purposes are expressed. For example, an abstractive technique might use a relatively unconstrained vocabulary to convey purposes as well as topics. The disclosed implementations can distill a given information item down to one or only a few enumerated purposes, and each summary includes one or more of those purposes. Moreover, by predefining the purposes ahead of time, the disclosed implementations can capture the most common or important communication purposes associated with conversational information items, yet nevertheless significantly reduce the space from which purposes are extracted.

In addition, conventional techniques for summarizing information often do not consider user context or user preferences. Technological innovations that allow location-tracking and user presence detection have enabled robust detection of user context, including mapping the user's physical location as determined by GPS or Wi-Fi to a logical location, such as at home, work, or commuting. By considering user context and/or a user profile, the disclosed implementations can rank topics and purposes so that the summaries tend to include topics and purposes of interest to the user. Thus, for example, even if an email is primarily directed to a first topic that is not of interest to a user, the user may be provided a summary of that email that is nevertheless focused on a second topic in the email that is of interest to the user.

Furthermore, note that the summaries generated above are exemplary and other implementations are contemplated. For example, purposes, topics, and relationships are but a few examples of values that can be extracted from information items and included in compressed representations. Other implementations might extract values such as whether the author is expressing a positive or negative sentiment, whether the author is using professional language or colloquial language, whether the information item contains an urgent action item, etc., and any or all of these values can be included in a summary or other compressed representation.

Furthermore, note that single-sentence summaries are but one example of a compressed representation that can be generated using the techniques discussed herein. Other implementations can generate multiple-sentence summaries for a given information or partial sentences (e.g., phrases). Further implementations can store compressed representations of information items in various formats, e.g., a spreadsheet or database, and index the spreadsheet or database by the extracted values. This can allow for efficient storage and retrieval of information items that share common extracted values. For example, conventional email storage techniques might make it difficult for a user to easily identify all emails where another user informed them of an opinion. By indexing emails and/or email summaries according to extracted purposes, the disclosed implementations can enable automation of purpose-based search over a large database of underlying information items.

### Model Selection and Training

As noted, the item information extraction module 204, the item information ranking module 212, and/or the item representation generation module 214 can be implemented using various machine learning models discussed herein. Each of these models can be trained using one or more of supervised, semi-supervised, and/or reinforcement learning. As also noted, some implementations can augment machine learning models with rules to override incorrect behavior that may arise. The disclosed techniques can be performed with many different types of machine learning models.

However, some machine learning models may tend to require significant amounts of training data to achieve reasonable performance. For example, neural networks can perform very well in natural language processing and generation scenarios such as those disclosed herein, but often require extensive training on large data sets to do so. In addition, the training of neural networks can involve expensive hardware such as high-performance graphics processing units.

As a practical matter, however, summarization of conversational information items such as emails or forum threads has not received extensive treatment. As a consequence, there is a relative lack of available training data for training machine learning models to summarize such documents. Similarly, there is a relative lack of training data suitable for training models to detect purposes and topics of conversational information items. Furthermore, even assuming such training data were available, it may be nevertheless more convenient or less expensive to use conventional processors rather than expensive hardware to perform model training.

To address these concerns, some implementations may select machine learning models that can give reasonable performance with relatively few training examples, and that are suitable for training on inexpensive hardware. For example, as noted above, some implementations may use support vector machines to detect the purpose of a given information item. In some cases, each purpose has an associated binary detection model that outputs a yes/no answer for that particular purpose, and/or a confidence or probability value reflecting how likely the input information item is associated with the purpose for that binary detection model.

As there are not extensive training examples of prior emails labeled with purposes, some implementations may initialize the support vector machines using a data set tailored to another domain. In one specific example, a labeled corpus of speech acts is used for initial training. For example, there are existing speech act corpora that label in-person or telephonic discussions of human beings with labels for individual speech acts. Some of these labels may have semantic similarities to the purposes discussed herein. As one specific example, the AskQuestion purpose might correspond to the following speech act labels—Yes/No questions, “Wh” questions (who, what, why), rhetorical questions, declarative questions, open-ended questions, etc. After initially training the purpose detection models on speech act data, a smaller set of labeled email (e.g., annotated with purposes) can be used to refine the purpose detection models. Once trained, the purpose detection models for each purpose can classify associated information items as a binary yes/no indicating the presence or absence of that purpose, along with a corresponding confidence value for the classification. Thereafter, some users may willingly opt-in to label purposes generated by the models as true or false, and these labels can be used to refine the purpose detection models over time. In the particular case of a support vector machine, the models can adapt quickly to new training examples and thus provide relatively high purpose classification accuracy in a relatively short period of time.

A similar approach can be used for a topic detection model, which can be trained initially using supervised learning for topics. In some implementations, gradient-boosted decision trees can be used to perform topic detection. For example, given a newspaper corpus, the model can be initially trained to replicate topics referenced in the headlines. In other words, the headlines serve as topical annotations, and the topic model learns by receiving positive feedback when it selects a word or words in the newspaper article that also appears in the title, and negative feedback otherwise. Subsequently, the topic generation model can be refined using a small amount of annotated email data. In this case, the subject line of the email can serve a similar purpose to the titles of the newspaper articles by acting as topical annotations. In other words, the topic model can receive positive feedback when it selects a topic word that appears in the subject line of an email, and negative feedback otherwise. Note, however, that email subjects may be somewhat less accurate than news paper headlines as topical annotations. Thus, some implementations use, as training data, manually-labeled email data indicating whether the subject accurately reflects the true subject of the email. As with the purpose models, once the topic model is placed into use, users can opt-in to provide explicit yes/no evaluations of topics produced by the topic model, and the topic model can be refined accordingly.

As noted, the topic model can be implemented using gradient-boosted decision trees. In some cases, decision trees are trained to evaluate features extracted from newspaper articles or emails using a neural network. For example, the neural network can process a one-hot encoding of the words in a given sentence and output word or sentence encoding features that represent meaning of individual words or sentences in a semantic space. Alternatively, the neural network could receive word encodings as inputs and be trained to output sentence encodings. For example, the neural network could receive GLOVE (“Global Vectors for Word Representation”) word encodings as inputs and output sentence encodings.

The neural network can also extract structural features that represent where, in a given training example, a word appears—e.g., beginning or end of a document, paragraph, or sentence, etc. The word encodings, sentence encodings, and/or structural features can be used as input features for the topic model. The topic model can also use other features that measure of the importance of each word, e.g., a TF-IDF (term-frequency inverse document frequency) value. Given such features, the decision trees of the topic model can learn to take an information item or collection of information items, and generate one or more potential topics along with corresponding confidence scores.

In some cases, the ranking model can also be implemented using gradient-boosted decision trees that output ranked purposes, topics, and/or relationships as a function of context, the user profile, and signals within a given information item. The topic and/or purpose models could provide a confidence value for each topic/purpose that serves as an input feature for the ranking model. Further implementations can provide user-specified weights or learned weights for each topic or purpose to the ranking model for use as features. This can allow certain purposes or topics to be preferentially selected by the ranking model even if other purposes/topics are given higher confidence by the purpose/topic models. The ranking model can also take user profile information as features so the ranking model iteratively learn over time how user profiles influence whether users perceive a given summary as valuable. Similarly, the ranking model can also take user context information as features so the ranking model iteratively learn over time how user context influences whether users perceive a given summary as valuable.

As noted above, some implementations can use automated and/or manual techniques to evaluate generated summaries. In either case, the feedback can be used to generate new labeled training data for subsequent iterations of training, and/or for reinforcement learning of the various models discussed herein. Generally, the disclosed implementations aim to provide quality summaries while maintaining low cognitive load. More complicated summaries are more likely to accurately characterize a given information item or information item collection, but at the same time are also likely to impose higher cognitive loads on users. Thus, some implementations use criteria for model evaluation that measure both summary quality and cognitive load, as discussed more below.

Various automated approaches can be used to evaluate and/or train the models. For example, the purpose of an email can be evaluated using metrics reflecting accuracy, precision, recall, F-score, and/or other metrics that can be automatically computed from an annotated reference of the true desired purpose. For topics, the information items can be projected into a semantic space together with the generated topics. The closer the two representations are to one another in the semantic space, the more likely it is that the topic is accurate.

For summarization quality, Recall-Oriented Understudy for Gisting Evaluation or “ROUGE” can be used as an evaluation metric. In some cases, the summaries are compared to human-generated summaries for the information items. The ROUGE metric can be computed using an automated tool that compares the two summaries and outputs a metric indicating how well the automated summary approximates the human-generated summary.

Generally, complex sentences impose relatively higher cognitive loads on users than simple sentences. Thus, one way to approximate the cognitive load of a given summary is to measure the sentence complexity of that summary. Generally, sentence complexity measures can consider lexical complexity, syntactic complexity, and/or semantic complexity and compute a single aggregate score by weighting each of the three metrics and summing them.

In addition to automated evaluation techniques, some implementations can also use human evaluation of generated summaries. To do so, humans can be asked a series of questions, such as how accurately a given summary captured the purpose or topic of a given information item, how intelligible and/or coherent the summary was, how easy the summary was to understand, etc. Other questions could ask the user whether the summary provided enough information to decide whether they should read the information item in its entirety at a later time, and whether any information was missing that the user would have liked to have in the summary.

To measure the cognitive load on human users, some implementations may ask users to perform simple tasks, such as playing a board game, while assessing the quality of a given summary. Generally, users should be able to provide similar answers to the questions set forth above regardless of whether they are performing a simple task, provided the summary does not impose a great cognitive load on the user.

Given automated and/or human feedback, the models can be improved. For example, a measurement value for each purpose, topic, and/or summary can be generated. Next, the output of the measurement function can be used to replace or augment a reinforcement learning engine that is used to further train the respective models. Thus, the models can improve over time and generate higher-quality, lower-cognitive load summaries.

Moreover, as noted above, the disclosed implementations can be performed using models such as support vector machines or gradient-boosted decision trees that do not necessarily require vast numbers of training examples. In addition, the disclosed implementations enable the use of such models by decomposing summarization into several discrete, manageable tasks. For example, restricting the space from which purposes and topics are extracted enables the use of corresponding models that do not require vast numbers of purpose- or topic-labeled examples. Moreover, because the ranking model operates on examples that have been projected into manageable purpose and topic domains, the ranking model can also be implemented using models that are amenable to training with relatively few labeled examples.

In addition, some implementations may also learn parameters for the item representation generation module 214. Instead of generating a single summary sentence reflecting the highest-ranking purpose/topic pair, the generation module can be trained to vary its output depending on context. For example, if users consistently prefer shorter summaries when driving and longer summaries when at home, then the generation module can be trained to generate single summary sentences with one purpose/topic pair when a user is driving, but to generate multiple summary sentences with multiple purpose/topic pairs when the user is at home.

### Second Example User Experience

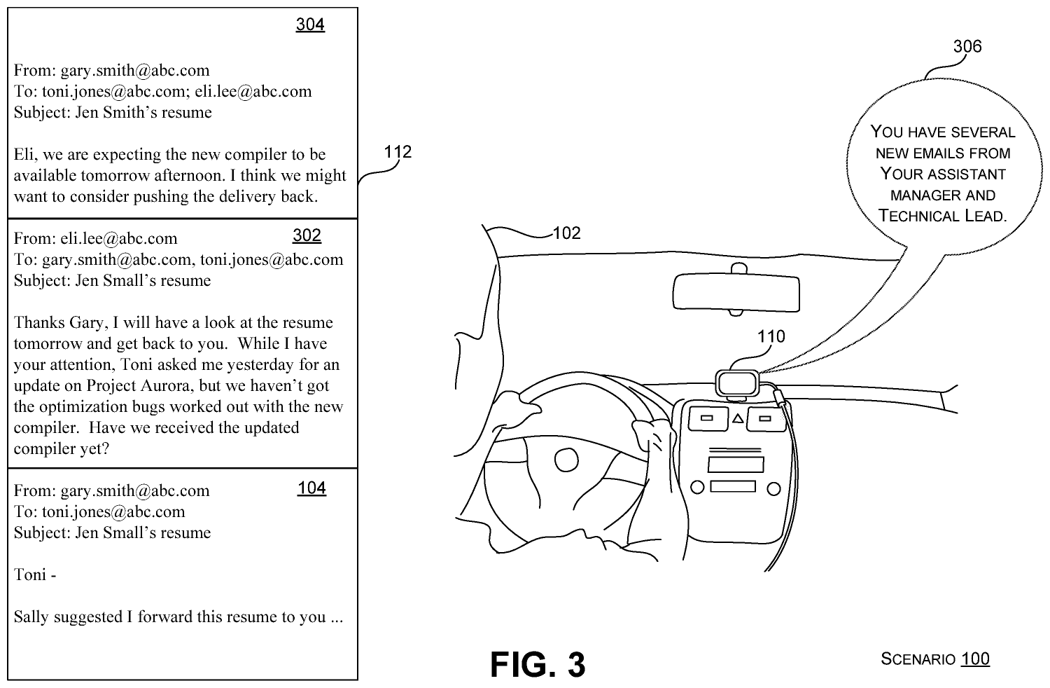

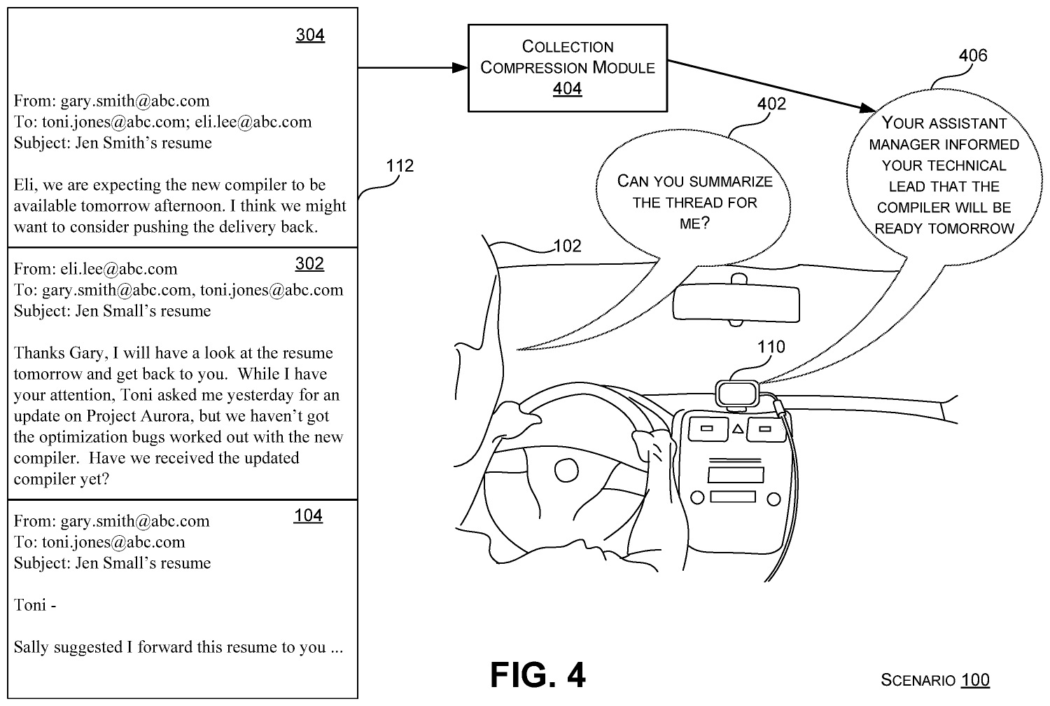

FIGS. 3 and 4 collectively illustrate a continuation of scenario 100. Here, user 102 has received several subsequent emails, including email 302 and email 304, which are included in email thread 112. Email 302 is from a software engineer named Eli Lee, and email 304 is from assistant manager Gary Smith. In FIG. 3, the user's mobile phone provides an announcement 306 indicating that the user has received several new emails. Instead of requesting individual email summaries, the user issues a request 402 for a collective summary of the email thread, as shown in FIG. 4. The email thread can be processed by a collection compression module 404, which provides a compressed representation 406 of the email thread for reproduction by the user's mobile device 110 in a manner previously discussed with respect to FIG. 1.

In this example, as discussed more below, Eli has acknowledged receipt of the resume. Eli has also changed the topic to discuss some compiler issues that have slowed delivery of a software project called “Project Aurora.” Gary has responded to Eli's concern by informing him that the compiler issues will likely be resolved tomorrow.

### Example Collection Compression Module

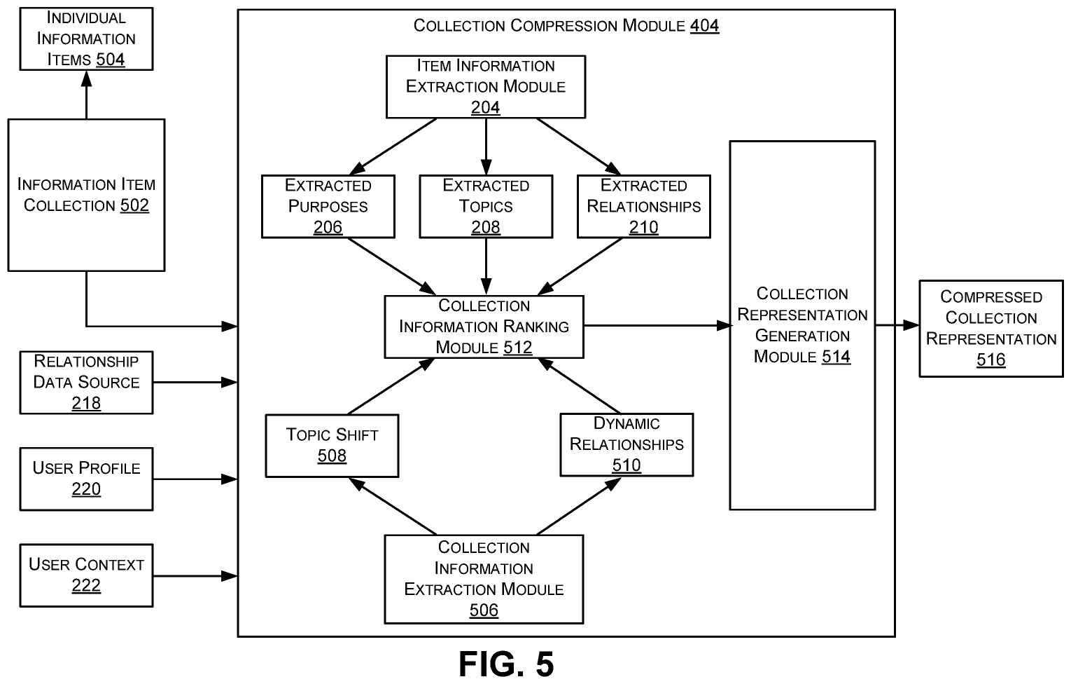

FIG. 5 illustrates exemplary components collection compression module 404. Generally, the collection compression module is similar to the item compression module 106 discussed above, with some additional and/or modified components that can enable summarization of collections of information items. Unless otherwise discussed herein, the description above of each component of the item compression module above applies to like components of the collection compression module.

One approach for generating a compressed representation of a collection of information items is simply to generate separate representations of each individual information item, and concatenate them. However, this approach can generate relatively long representations of the collection, e.g., one or more summary sentences per information item. Thus, some implementations adopt the following approach.

Given an information item collection 502, such as an email thread or a forum discussion, the individual information items 504 (e.g., each email, each forum post, etc.) can be separately processed by the item information extraction module 204 to extract item-specific purposes, topics, and/or relationships between participants, as discussed above with respect to FIG. 2. Additionally, a collection information extraction module 506 can extract information that pertains to the collection of information items as a whole. For example, the collection information extraction module can determine whether the topic of the collection has shifted over time, and output a topic shift 508. In addition, the collection information extraction module can detect relationships that change over the course of time within the collection, e.g., are subgroups forming, is one author dominating the decision-making process, is someone acting as expert, etc. This information can be output as dynamic relationships 510. The information extracted for each individual information item as well as the collection information can be ranked by a collection information ranking module 512 and then processed by a collection representation generation module 514 to generate a compressed collection representation 516 of the entire collection of information items. Note that collection information ranking module 512 can be similar to item information ranking module 212, except as otherwise indicated herein. Likewise, collection representation generation module 514 can be similar to item representation generation module 214, except as otherwise indicated herein.

### Second Specific Summary Generation Example

The following discusses how the collection compression module 404 might generate the compressed representation 406 shown in FIG. 4, which states that “Your assistant manager informed your technical lead that the compiler will be ready tomorrow.”

First, the item information extraction module 204 can extract item-specific purposes, topics, and/or relationships for each individual email. Initially, the item-specific purposes, topics, and/or relationships for a given email can be ranked relative to one another, as previously discussed. For example, email 302 can have purposes ConfirmActivity and AskQuestion, and topics “Jen's resume” and “compiler update.” This reflects the idea that Eli is confirming that he will review Jen's resume, and also asking Gary whether the compiler update is available. Email 304 can have purposes “InformFact” and “InformOpinion,” and topics “compiler available tomorrow” and “push delivery back.” This can reflect the idea that Gary is informing Eli of the fact that the compiler update will probably be available tomorrow, and his opinion that the delivery should be delayed.

Now, assume that the item information ranking module 212 of the item compression module 106 initially ranks the topic of Jen's resume higher than the topic of compiler when considering email 302 in isolation. This could be due to the user profile 220 for Toni Jones, which indicates that this user has previously expressed greater interest in hiring decisions than in compiler issues. However, the collection information extraction module 506 may detect that the topic of the collection as a whole has shifted to the compiler issues and away from Jen's resume. As a consequence, the collection information ranking module 512 of the collection compression module can select a collection-wide topic that relates to the compiler issue instead of Jen's resume. In addition, the InformFact purpose is associated with the compiler issue in the most recent email. Thus, the collection information ranking module 512 can rank the InformFact purpose and the compiler issue topic jointly as the highest-ranking purpose and topic, respectively.

Also, note that the sentence structure of compressed representation 406 for the collection in this example is somewhat more complex than the sentence structure of compressed representation 108, for an individual email. In some cases, the collection representation generation module 514 can use more complex grammars for generating summaries of information item collections than the item representation generation module 214. This allows the collection representation generation module to include more information and potentially inter-related ideas in the collection summary, when appropriate given the user's cognitive burden. In other cases, however, collection representations can adopt similar structures to the previously-discussed item representations. For example, simpler sentence structures might be used when the user's context indicates a high cognitive burden, or when one topic-purpose pair is much higher-ranked than the next highest-pair.

The previous example shows how topical shift can inform the generation of a summary for a collection of information items. Topical shift can be detected using sequence models, such as hidden Markov models or conditional random fields. As also noted, dynamic and static relationships can also be used for generating a summary of an information item collection. For example, the dynamic relationships 510 can convey information such as which individuals authored individual information items, which individuals are merely cc′d and have not directly contributed to the conversation, etc. For example, if an individual is cc′d on all emails in a thread and is not directly addressed by any of the emails, then the collection summary can focus on the collection as a whole without considering any individual email as being more important than another. Alternatively, if the individual is a direct recipient of some emails on a thread and only cc′d on others, or if the individual is directly addressed by name in only a subset of emails, then the collection summary can focus on that subset of emails.

As another example, some implementations may detect dynamic relationships when users tend to address one another or discuss common topics. When this occurs, individual users can be clustered into sub-groups. If a user is a member of a particular sub-group, the collection summary for that user can tend to focus on topics or purposes associated with that sub-group. Group formation can be detected using algorithms such as support vector machines, decision trees, maximum entropy models, or logistic regression models to characterize participants and then partitioning the participants into subgroups. As another example, if a user is acting as an expert on a particular topic, some implementations can rank information provided by that user relatively higher with respect to that topic, and preferentially include information from that expert user in the collection summary relative to other information on that topic provided by non-experts. Note that in the previous example, Gary seems to have more information that Eli on the compiler topic, and this information can be captured by detecting a dynamic relationship with Gary acting as an expert with respect to this topic. Expert detection can also be implemented using algorithms such as support vector machines, decision trees, maximum entropy models, or logistic regression models

In addition, note that some collection summaries can convey aggregate values for a given collection. Assume email thread 112 continues by adding additional users to discuss whether the delivery should be pushed back. If five users ultimately opine that the delivery should be pushed back and two disagree, then a new collection summary could be generated that says “Five people have the opinion that the delivery should be pushed back, and two people disagree.” To generate a summary such as this, individual users can each be associated with a given topic, purpose, and sentiment, and the number of users that share sentiment for a given topic/purpose pair can be aggregated. A template or grammar can be defined such as “[NUM_1] have opinion [TOPIC][SENTIMENT], and [NUM_2] disagree.” Thus, the template includes fields for the number of users in two distinct groups, as well as fields that convey sentiments of the two groups with respect to a particular topic.

Another example of a collection summary can involve detection of resolved issues. For example, suppose an email chain begins with a request for all recipients to respond to a particular question, e.g., whether they have taken their annual mandatory training. Initially, a summary for the collection might be “You need to confirm you've done your annual training.” However, subsequently, an expert user may state that “annual training is no longer required for department managers.” In this case, the summaries could be bifurcated so that users who are department managers receive a summary such as “You are no longer required to take annual training,” whereas other users continue to receive the summary “You need to confirm you've done your annual training.”

### Third Example User Experience

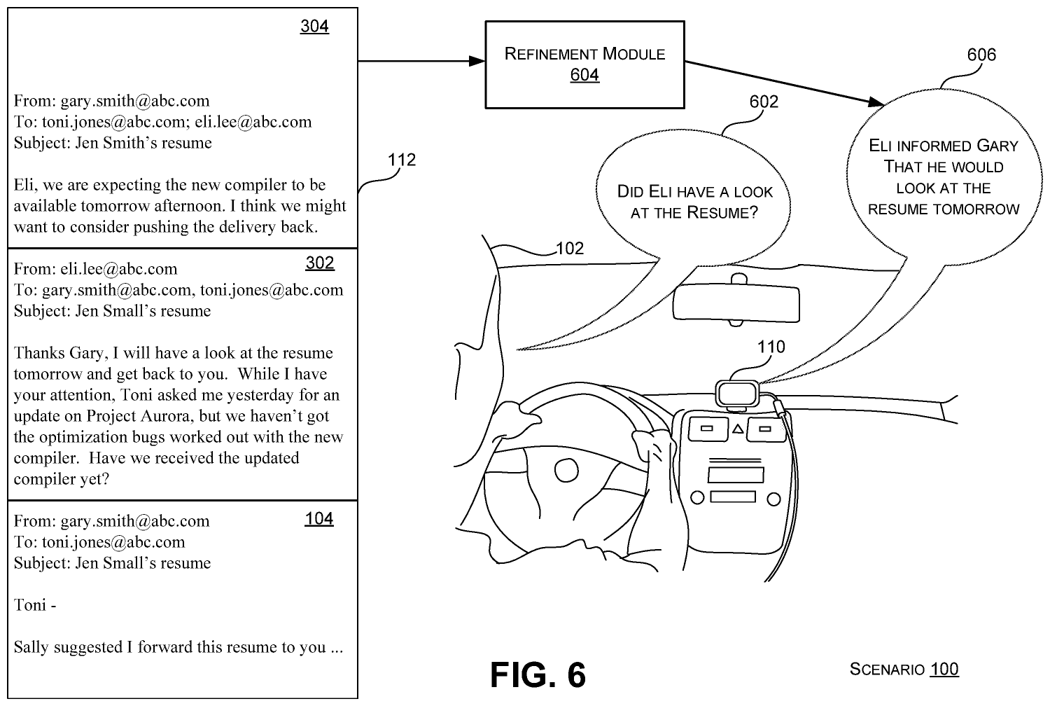

FIG. 6 illustrates a further extension of scenario 100. Here, user 102 has issued a query 602 that requests additional information. The email thread can be processed by a summary refinement module 604, which provides a refined representation 606 in response to the user's query. In this example, the mobile phone announces that the user's technical lead, Eli, has informed Gary that he will review the resume tomorrow.

### Summary Refinement

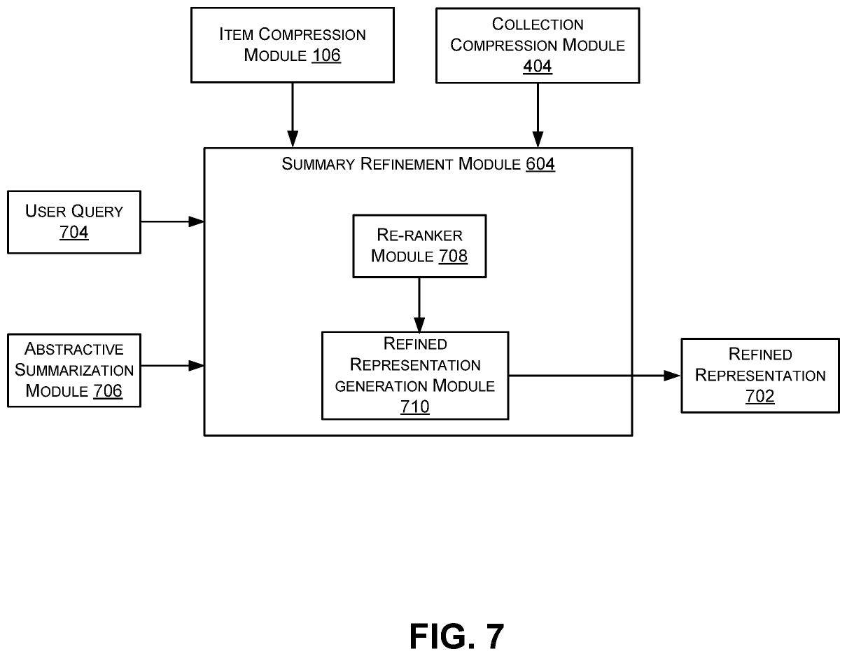

FIG. 7 illustrates exemplary components of a summary refinement module 604. Generally speaking, the summary refinement module can produce a refined representation 702 based on input provided by the item compression module 106, collection compression module 404, a user query 704, and/or an abstractive summarization module 706, as discussed more below.

Generally speaking, the user query 704 can be provided by a user after receiving a compressed representation of a given information item or collection of information items. The abstractive summarization module 706 can output an abstractive summarization of the information item or collection of information items. The item compression module 106 can provide compressed representations of a given information item or collection of information items, as well as any extracted topics, purposes, relationships, or other values provided by the item information extraction module 204. The collection compression module 404 can also provide any dynamic relationships or topic shifts detected by the collection information extraction module 506.

Any or all of the aforementioned information can be processed by a re-ranker module 708 via a re-ranking process, given the user query and potentially any changes in the user context. Subsequently, refined representation generation module 710 can generate a refined representation based on the re-ranked information, as discussed more below. For example, the refined representation can be a compressed representation as well, e.g., a natural language summary that is generated according to a predefined grammar or template, as previously discussed.

### Targeted User Requests

In some cases, the user may ask for more specific summary expansions, by explicitly requesting for details on a particular aspect of a given summary. Possible summary expansions for a single information item may include, for example, a more detailed description of the topic, more information about the interactants, or more specific descriptions of the interaction purposes. Possible expansions for summaries of information item collections include richer information about some of the social interaction aspects, such as details about the interactant relationships, as well as providing individual quick summaries for each of the information items in the collection. In the example set forth above, the user requested further information on the “compiler” topic discussed in the two most recent emails.

To request a targeted summary expansion, the user can issue a query as shown in FIG. 6. The summary refinement module 604 can respond by considering both the collection of information items and the previously-generated summaries for items in that collection. Thus, for example, user 102 has previously been informed that Jen Small has provided a resume for consideration. However, the user has not been informed as to whether Eli has viewed the resume. As a consequence, the refined summary shown in FIG. 6 introduces these new facts to the user.

To accomplish this, the re-ranker module 708 can re-rank the purpose, topic, and/or relationships in a given information item based on the user query 704. Given these re-ranked values, the refined representation generation module 710 can generate one or more refined summaries based on the re-ranked information. As one example, initially, the resume topic may have been ranked below other topics as discussed previously, since the topic of the email chain has shifted away from the resume to compiler issues. However, given the user request for more information about the resume, the resume may be re-ranked to be higher than the other topics. Thus, the resume topic may be the highest-ranked topic input to the refined representation generation module 710. As a consequence, the summary sentence that is output in response to the request pertains to the resume topic.

In further implementations, the re-ranker module 708 can also consider whether information has been acknowledged. For example, assume early in an email chain that the user's supervisor requests that the user confirm attendance at a professional event. Several emails later, the user may request additional information about an unrelated topic, e.g., the holiday party. The re-ranker module can consider the relationship between the supervisor and the user, track that the user has not acknowledged the request with respect to the professional event, and rank the professional event higher than the holiday party despite the user's query being directed to the holiday party. Thus, the refined representation generation module 710 could generate a statement such as “Your Vice President has a question about the professional event that you have not answered”

### General Refinement Requests

In some cases, the user may not request information on a specific topic, but instead may simply request more general information. For example, assume the user says “tell me more.” In this case, the summary refinement module 604 might respond with an answer such “Your assistant manager's opinion is that we should push the Project Aurora delivery back.”

The approach to answering general requests for more information can depend on whether the user is requesting additional information with respect to a summary of a single information item, or a collection of information items.

For a single information item, the item information extraction module 204 of the item compression module 106 may produce purposes, topics, and/or relationships that do not appear in the initial summary generated for that information item. Thus, if the user asks for more general information about the information item (e.g., email 304), the re-ranker module 708 can re-rank the remaining purposes, topics, and/or relationships for that specific information item. In some cases, the refined representation generation module 710 can use a restricted grammar to generate one or two summary sentences for the highest-ranking remaining purposes, topics, and/or relationships. In other cases, the generation module can generate a more thorough abstractive summary of the highest-ranking remaining purposes, topics, and/or relationships.

For a collection of information items, in some cases, the summary refinement module 604 can output previously-generated summaries for selected individual information items in the collection. One approach is for the re-ranker module 708 to re-rank the previously generated summaries for individual information items relative to one another, and output one or more of the highest-ranking remaining summaries. Another approach is for the re-ranker module to rank individual information items in the collection relative to one another, and to generate an abstractive summary for a highest-ranking subset of the information items.

### Additional User Experiences

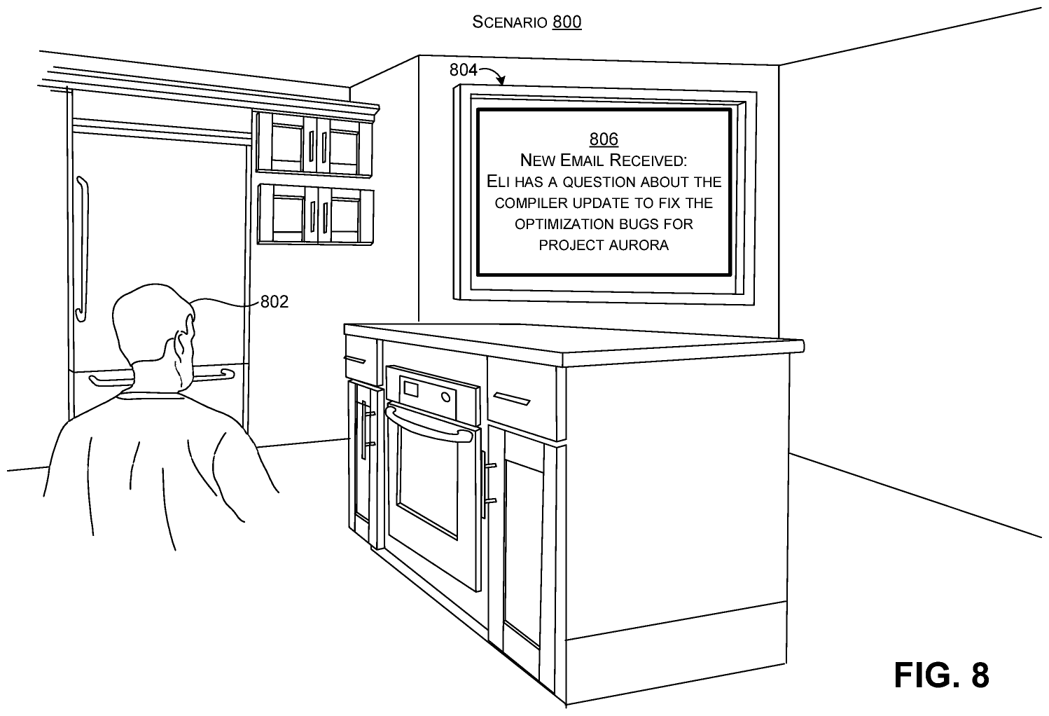

The disclosed implementations are not limited to driving scenarios, and can be employed to assist users in various contexts. For example, FIG. 8 shows a scenario 800 where a user 802 is in a kitchen with a display 804. For example, the user may have been watching television on the display and doing work in the kitchen when an email is received. Assume, for the purposes of illustration, that user 802 is Gary Smith from the previous examples, and the received email is email 302 from FIG. 3.

In this case, a compressed representation 806 can be provided in the form of a natural language summary for Gary. Note in this case that the somewhat more syntactically complex than the previous driving example. This can be a consequence of Gary's context, working in the kitchen, being somewhat less demanding than driving a car. As a consequence, the compressed representation may be generated using a grammar that allows more complex sentence structures. For similar reasons, summaries provided in less cognitively demanding contexts may be more semantically and/or lexically complex than those provided in more cognitively demanding contexts.

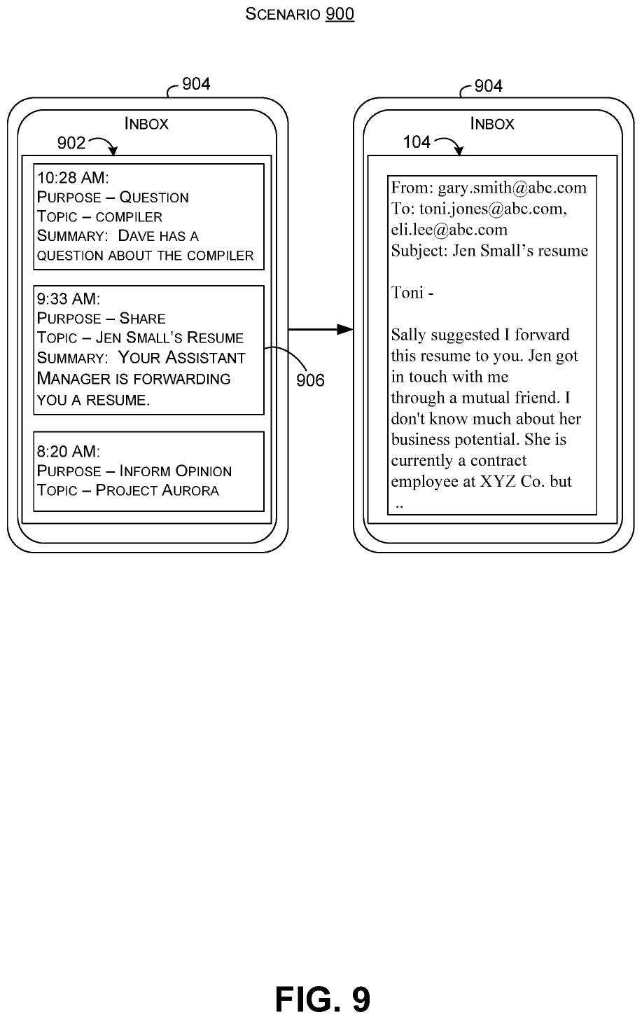

FIG. 9 shows an email scenario 900 where a user is provided with a summarized email inbox 902 on a mobile device 904. As shown in FIG. 9, the summarized email inbox can include email summaries for individual emails, which can replace conventional email previews. Note that each email summary includes a summary sentence as well as a purpose and topic associated with that particular email. Assume that a user selects email summary 906 from summarized email inbox 902, e.g., using a touch input. Next, the mobile device 904 can show the full email 104, as also shown in FIG. 9.

Note that the compressed representations discussed herein can save network bandwidth under some circumstances. For example, in some implementations, the user's mobile device can be pushed email summaries from an email server by default, rather than entire emails. In such implementations, the full emails may be retrieved from the email server only after the user affirmatively requests to see a given email. This can conserve both server resources and network bandwidth, while at the same time giving the user some understanding of what each email pertains to.

### Applications

There are many different applications where the item compression module 106 and/or refinement module 604 can be deployed. One approach is to incorporate these modules into a digital assistant that allows a user to interact via spoken commands with one or more computing devices. Scenarios 100 and 800 discussed above give examples of how digital assistants might convey summaries to users. In some cases, a digital assistant can also be integrated with other applications, such as an email program. Scenario 900 shows an example of how this can be accomplished.

In other implementations, summarization can be performed by a search engine. For example, consider a user searching for information on web forums about used cars. The user might enter a query into a search engine home page, such as “Do front-wheel drive cars get better gas mileage than all-wheel drive cars?” The search engine might identify some search results with collections of information items, such as a forum thread where various users discuss the relative fuel economy of different cars. In this case, the disclosed techniques can be used to generate a summary of the entire forum thread or individual forum posts. Individual forum threads or posts that specifically relate to front-wheel drive vs. all-wheel drive fuel economy might be ranked relatively higher for summary generation purposes than more general discussions, in view of the topical interest expressed by the initial query.

As another example, a website that sells products online might offer users the capability of providing reviews of products that they purchase. In some cases, the reviews will have comments associated with them, and can result in a dialogue between multiple users. In this case, summaries of product reviews can be generated using the disclosed techniques. In some cases, a customized set of enumerated review purposes could be defined that might be different than those discussed above with respect to emails. For example, purposes could relate to criticizing product features, criticizing the price of a product, criticizing the merchant, etc.

### Example System

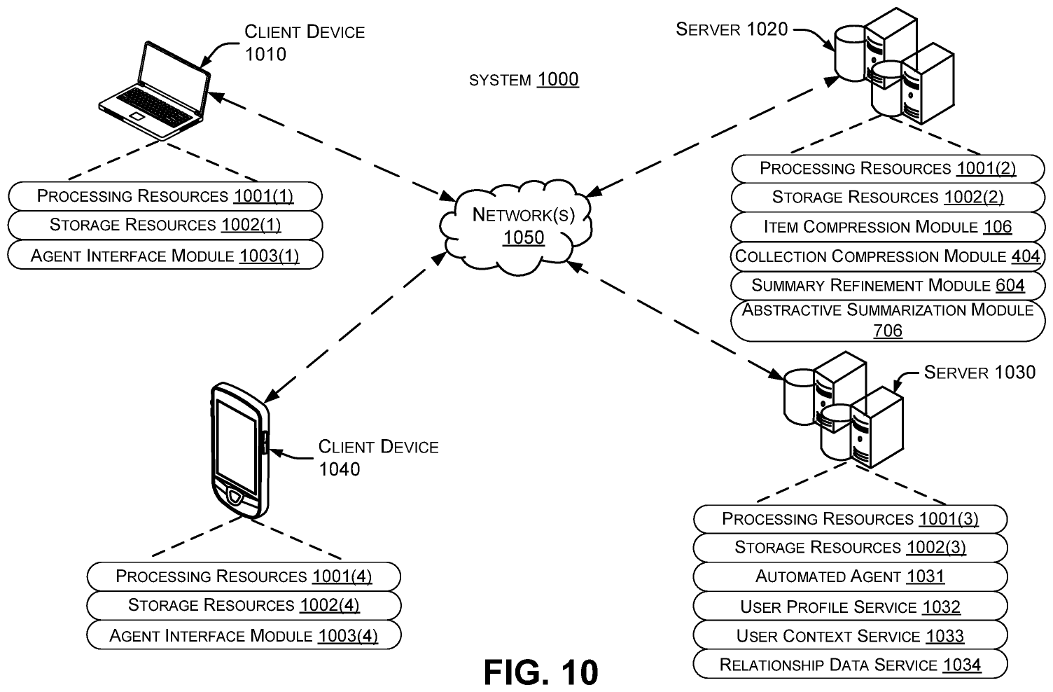

The present implementations can be performed in various scenarios on various devices. FIG. 10 shows an example system 1000 in which the present implementations can be employed, as discussed more below.

As shown in FIG. 10, system 1000 includes a client device 1010, a server 1020, a server 1030, and a client device 1040, connected by one or more network(s) 1050. Note that the client devices can be embodied both as mobile devices such as smart phones or tablets, as well as stationary devices such as desktops, server devices, etc. Likewise, the servers can be implemented using various types of computing devices. In some cases, any of the devices shown in FIG. 10, but particularly the servers, can be implemented in data centers, server farms, etc.

Certain components of the devices shown in FIG. 10 may be referred to herein by parenthetical reference numbers. For the purposes of the following description, the parenthetical (1) indicates an occurrence of a given component on client device 1010, (2) indicates an occurrence of a given component on server 1020, (3) indicates an occurrence on server 1030, and (4) indicates an occurrence on client device 1040. Unless identifying a specific instance of a given component, this document will refer generally to the components without the parenthetical.

Generally, the devices 1010, 1020, 1030, and/or 1040 may have respective processing resources 1001 and storage resources 1002, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 1010 and 1040 can include an agent interface module 1003 that can interact with an automated agent 1031 on server 1030. Generally speaking, the automated agent can be any type of service that provides information items to a user. For example, the automated agent can be a digital assistant, search engine, social media service, online shopping service, etc. The agent interface module can provide any client functionality suitable for interacting with a given online agent. For example, the agent interface module can be a web browser, a local mobile app, a plug-in, etc.

Server 1030 can also host a user profile service 1032, a user context service 1033, and a relationship data service 1034. Referring back to FIG. 2, these services can provide user profile 220, user context 222, and relationship data source 218 over network(s) 1050 to server 1030. Server 1020 can host item compression module 106, collection compression module 404, summary refinement module 604, and/or abstractive summarization module 706. In some implementations, automated agent 1031 on server 1030 may act as an intermediary by obtaining user input from the respective client devices 1010 and 1040, obtaining compressed representations and refinements from server 1020, and providing the compressed representations to the respective instances of the agent interface module 1003.

### Example Method

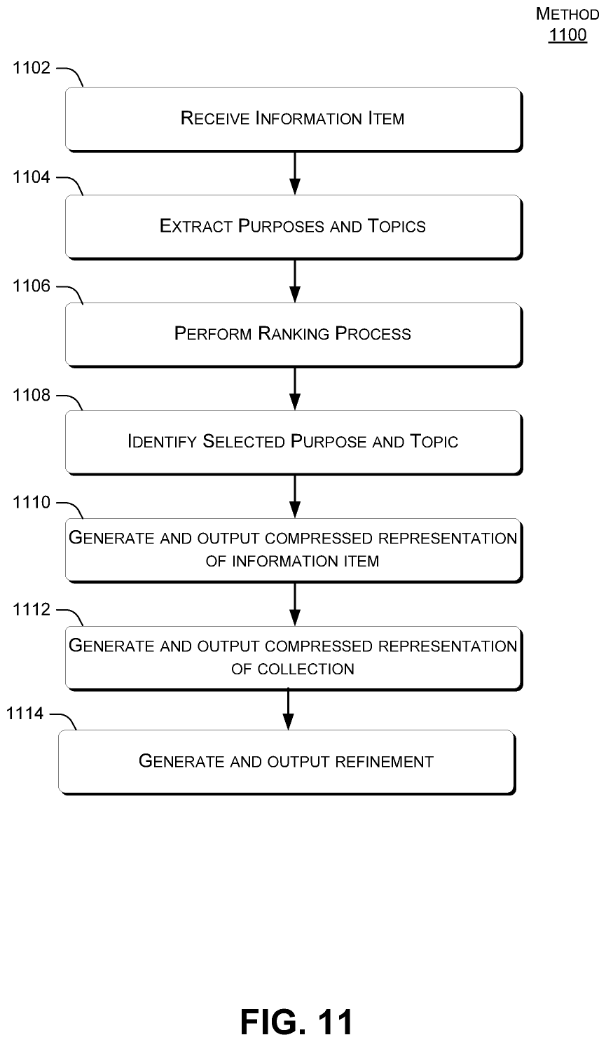

FIG. 11 illustrates an example method 1100, consistent with the present concepts. Method 1100 can be implemented on many different types of devices, e.g., by one or more cloud servers, by a client device such as a laptop, tablet, or smartphone, or by combinations of one or more servers, client devices, etc.

Method 1100 begins at block 1102, where an information item is received. As noted previously, the information item can be a conversational information item or a non-conversational information item. In some cases, the information item is part of a larger collection of information items.

Method 1100 continues at block 1104, where values such as purposes and topics are extracted from the information item. As noted above, purposes can be extracted from an enumerated space of purposes that is predefined, whereas topics can be extracted from a topic vocabulary space that dynamically varies with the content of the underlying information item or collection.

Method 1100 continues at block 1106, where a ranking process is performed on the extracted values. The ranking process can range from a simple rule-based approach to a complex machine-learning approach that adapts over time as new training examples are generated.

Method 1100 continues at block 1108, where selected values, such a selected purpose and a selected topic, are identified based on the ranking process. As noted above, the selected values can be identified as one or more of the highest-ranking values output by the ranking process.

Method 1100 continues at block 1110, where a compressed representation of the information item is generated and output. As noted above, the compressed representation can be a natural language summary of the information item that is generated using a predefined grammar or template. In other implementations, the compressed representation is not necessarily provided in a natural language format, e.g., one or more highest-ranking purposes, topics, and/or relationships can be output directly without being converted into a natural language format. Instead, for example, these purposes and topics could be used to populate a data structure such as a database index or an email notification. Generally, outputting can involve sending the compressed representation over a network, displaying the compressed representation on a display device, or otherwise exporting the compressed representation for further handling by a human or machine.

Method 1100 continues at block 1112, where a compressed representation of a collection of information items is generated and output. As noted above, in some implementations, this is performed in response to an explicit user request.

Method 1100 continues at block 1114, where a refinement of the compressed representation of the information item, or a refinement of the compressed representation of the collection, is generated and output. As noted above, in some cases, this is performed in response to a targeted user query, e.g., on a specific topic. In other cases, this is performed in response to a general user request for more information on the collection.

Generally, blocks 1104 through 1110 can be viewed as a lossy compression process performed on an individual information item. Blocks 1102 through 1110 can be performed by item compression module 106 as discussed above, block 1112 can be performed by collection compression module 404, and block 1114 can be performed by summary refinement module 604 as discussed above.

### Device Implementations

As noted above with respect to FIG. 10, system 1000 includes several devices, including a client device 1010, a server 1020, a server 1030, and a client device 1040. As also noted, not all device implementations can be illustrated and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 1050. Without limitation, network(s) 1050 can include one or more local area networks (LANs), wide area networks (WANs), the Internet, and the like.

1. A method performed on a computing device, the method comprising:
receiving an information item for presentation to a user;
performing a lossy compression process on the information item, the lossy compression process comprising:
extracting purposes from the information item, the purposes being selected from a restricted space of purposes;
extracting topics from the information item, the topics being selected from a restricted topic vocabulary space;
performing a ranking process on the extracted purposes and the extracted topics;
based at least on the ranking process, identifying a selected purpose of the information item and a selected topic of the information item; and
generating a compressed representation of the information item, the compressed representation comprising the selected purpose and the selected topic; and
outputting the compressed representation.

2. The method of claim 1, wherein the information item is a conversational information item and the compressed representation is a natural language summary of the information item.

3. The method of claim 2, further comprising:
predefining an enumerated list of purposes,
wherein extracting the purposes comprises selecting the purposes from the enumerated list.

4. The method of claim 3, wherein extracting the purposes comprises:
inputting the information item into one or more purpose detection models.

5. The method of claim 4, wherein the information item is an email, the method further comprising:
performing at least some training of the one or more purpose detection models on a first training data set annotated with speech acts, at least one of the speech acts mapping to a particular purpose on the enumerated list; and
performing further training of the one or more purpose detection models on a second training data set comprising other emails that are annotated with purposes of the other emails.

6. The method of claim 4, wherein extracting the topics comprises:
inputting the information item into one or more topic detection models.

7. The method of claim 6, wherein the information item is an email, the method further comprising:
performing at least some training of the one or more topic detection models on a first training data set comprising non-conversational information items having topical annotations; and
performing further training of the one or more topic detection models on a second training data set comprising other emails that are annotated with topics of the other emails.

8. The method of claim 2, further comprising:
defining a topic vocabulary based at least on words present in the information item,
wherein extracting the topics comprises using words from the topic vocabulary.

9. The method of claim 2, further comprising:
training a ranking model to perform the ranking process, the ranking process involving a joint ranking of at least the extracted purposes and the extracted topics.

10. The method of claim 9, further comprising:
obtaining context information reflecting a current context of the user; and
inputting the context information to the ranking model to perform the ranking process.

11. The method of claim 2, wherein, in at least one instance, the natural language summary comprises a single sentence reflecting a single purpose and a single topic identified by the ranking process.

12. The method of claim 2, further comprising:
extracting a relationship between at least two information item participants; and
including the relationship in the natural language summary of the information item.

13. The method of claim 2, further comprising:
using a grammar to obtain the natural language summary given the selected purpose and the selected topic.

14. The method of claim 13, wherein generating the natural language summary comprises selecting the grammar from among multiple grammars based at least on a current context of the user.

15. A system comprising:
a hardware processing unit; and
a storage resource storing computer-readable instructions which, when executed by the hardware processing unit, cause the hardware processing unit to:
receive a collection of conversational information items that reflect communication among a plurality of participants;
extract one or more values from individual conversational information items of the collection;
identify collection information associated with the collection of conversational information items; and
using a predetermined grammar, generate a compressed representation of the collection based at least on the collection information and the one or more values extracted from the individual conversational information items.

16. The system of claim 15, wherein the one or more values extracted from the individual conversational information items include topics of the individual conversational information items.

17. The system of claim 16, wherein the compressed representation of the collection is a single phrase or sentence summarizing the collection or phrase, wherein the single phrase or sentence reflects:
at least one topical shift that occurs within the collection,
at least one topic associated with a subgroup of participants in the collection,
at least one topic associated with an identified expert participant, or
an aggregate value representing a number of participants that agree with respect to at least one topic.

18. A computer-readable storage medium storing instructions which, when executed by a processing device, cause the processing device to perform acts comprising:
receiving one or more information items;
performing a lossy compression process on the one or more information items, the lossy compression process comprising extracting values from the one or more information items and including the extracted values in an initial summary;
outputting the initial summary to a user;
receiving a user query responsive to the initial summary;
based at least on the user query, re-ranking the values extracted during the lossy compression process;
generating a refined summary based at least on the re-ranking; and
outputting the refined summary to the user.

19. The computer-readable storage medium of claim 18, the extracted values including topics of the one or more information items, the user query comprising a targeted query for more information on a specific topic, the acts further comprising:
re-ranking the topics based at least on the specific topic of the targeted request; and
generating the refined summary based at least on the re-ranking of the topics.

20. The computer-readable storage medium of claim 18, the extracted values including topics and purposes of the one or more information items, the user query being a general request for more information, the acts further comprising:
identifying remaining purposes and topics that are not included in the initial summary; and
generating the refined summary from the remaining purposes and topics.
